(19) United States
(12) Patent Application Publication
(10) Pub. No.: US 2009/0047397 A1
(43) Pub. Date: Feb. 19, 2009

(54) Composition and Method of Preparing Ready-to-Eat Cereal with Konjac Flour as a Main Ingredient

(76) Inventor: Jill S. Tang, Livingston, NJ (US)

Correspondence Address: Jill S. Tang, 10 Split Rock Road, Livingston, NJ, 07039, US

(21) Appl. No.: 11/778,615

(22) Filed: Jul. 16, 2007

(51) Int. Cl. A21D 13/06; A21D 13/08

(52) U.S. Cl. 426/273; 426/550

(57) ABSTRACT

The present invention discloses a method and composition of preparing ready-to-eat (R-T-E) cereal with konjac flour as a main ingredient. Based on the conventional method, innovations are made in mixing konjac flour with other ingredients in the composition as well as in drying the interim product. The appearance and physical property of the finale product are similar to that of the conventional R-T-E cereal, whereas konjac-associated health benefits are retained.

### TECHNICAL FIELD

The present invention relates to the composition and process of preparing R-T-E cereal. Specifically, new procedures and conditions are established to integrate konjac flour into the composition for its unique properties.

### BACKGROUND OF THE INVENTION

Konjac (Amorphallus Konjac K. Koch) plant is mainly distributed in the tropical region of Asia, Africa and Australia. It was reported in ancient Chinese literature that konjac plant was used as medicine for a variety of disease conditions, and it has been consumed by Chinese and Japanese for many centuries. It is currently used as food additive to serve the functions as lubrication or adhesion in the western world. It has been demonstrated in clinical studies that treatment with konjac glucomannan, an extract from the plant, is associated with significant weight loss in obese adults (Walsh et al, 1984) and obese children (Livieri et al, 1992). In addition, konjac glucomannan also demonstrated clinical benefits in treating hyperglycemia (Chen et al, 2003), hyperlipidemia, and constipation.

There is a long history of consuming konjac food in Asia. Raw material extracted from konjac plant can be made into “Tofu”-like food and cooked with other ingredients in China. Shirataki noodle is made of pure konjac flour, and it has been among most popular Japanese food for many centuries and was introduced to the US market in the recent years. However, since the appearance, texture and taste of Shirataki noodle are quite different from conventional pasta, this Asian food has not gained any significant market share in the western world.

Pertinent patents filed are mostly related to the application of konjac as food additives. U.S. Pat. No. 6,676,986 disclosed a method of making formed food products from food purees in which konjac was used as lubricant. U.S. Pat. No. 6,048,532 disclosed a glucomannan-containing composition for reducing cholesterol by rapid elimination of undigested fat from human body. U.S. Pat. No. 6,352,735 disclosed a method of mixing konjac flour and other ingredients with processed meat to form low fat meat product. U.S. Pat. No. 6,896,896 disclosed a method of adding sphingoglycolipids to foods or cosmetics, and one of the source of sphingoglycolipids is derived from konjac plant. U.S. Pat. No. 6,048,564 disclosed a method of using konjac as a gelling agent in an emulsion composition which was developed as a bakery shortening substitute. U.S. Pat. No. 6,429,190 disclosed a composition in which konjac glucomannan fiber (0.5-4 g) is included along with long chain fatty acids, calcium, potato fiber, whey protein and alfalfa. This nutritional composition in the form of dry powder is claimed to stimulate cholecystokinin (CCK) to enhance and extend satiety. In the products in which konjac is used as food additives, the amount of konjac is well below the threshold of generating any significant health benefit.

In order to have consumers in the western world accept konjac food and enjoy its health benefits, innovations need to be made in the following area:
Increase quantity.
Findings from clinical studies (Walsh et al, 1984; Livieri et al, 1992; and Chen et al, 2003) suggested that a significant amount of konjac glucomannan is needed to achieve health benefits. The current applications as food additives are at levels well below that threshold. Although increasing the amount of konjac is clearly indicated, technical challenges remain to integrate konjac flour into conventional compositions as a main ingredient, because of its unique properties.
Change formulation.
Effort in weight management always requires long-term commitment, and konjac needs to be integrated into formulations that are widely accepted and regularly consumed.

R-T-E breakfast cereal is an excellent choice of carrying konjac as a main ingredient. It is consumed by tens of millions of people everyday, and the consumers are mostly interested in its related heath and nutritional benefits. The present objective is to enhance its benefit profile through fabrication of cereal with konjac flour.

As compared to the conventional manufacturing process of R-T-E cereal product, the present invention comprises innovations in the following area: (1) konjac flour is added as a main ingredient occupying 3-10% of dry weight in the composition; (2) condition and procedure of mixing konjac flour with other ingredients in the composition. Simply blending the starchy ingredients will generate granules inconsistent of size and moisture. A multiple step procedure is created to solve the problem; and (3) conditions such as drying temperature and length were established for the unique property associated with konjac flour.

### SUMMARY OF THE INVENTION

The present invention is directed generally to incorporating konjac into the conventional composition and the related method of manufacturing R-T-E cereal. The present invention resides in part in adding a significant portion of konjac flour to achieve the claimed health benefits. The present invention further resides in part in the procedure and conditions of mixing konjac flour with other ingredients in the conventional composition, as well as the conditions of drying the interim product.

### DETAILED DESCRIPTION OF THE INVENTION

The conventional R-T-E cereal manufacturing process is followed, whereas the practice employed in the process is modified to integrate konjac flour as a main ingredient in the composition for it unique properties.

### Composition

Konjac flour: high quality, the amount is approximately 3-10% (dry weight basis) of the cooked cereal dough.

Other starchy ingredients in the composition include cereal grains, cut grains, grits or flours from rice, corn, wheat, oats, barley, rye, or other cereal grains. These starchy ingredients comprise about 70-85% (dry weight basis) of the cooked cereal dough.

Variety of the ingredients designed to improve the nutritional qualities of the product can be included, such as vitamin and/or mineral fortification, colors, flavors, salt, nutritive carbohydrate sweetening agents. Various liquid ingredients can also be added such as corn or malt syrup. Total additional ingredients can comprise approximately 0.5-10% of the total dry weight.

Water: pure, free from off-flavor, hardness<10, PH 7.5-8.5. The amount of water used is approximately 5-10 folds of the amount of konjac flour by weight.

### Mixing Preparation

Simply blending konjac flour with other starchy ingredients generates granules which are inconsistent in size, color and moisture with the remainder of the mixture. The modified procedure is to mix konjac flour with warm water first, and use it to dissolve other starchy ingredients, followed by mixing with the remainder liquid and solid ingredients respectively.

The following is a detailed procedure of mixing all the ingredients in the composition. First prepare warm water (45° C.-55° C.) which is approximately 5-10 fold of the amount of konjac flour by weight. With constant mixing, add konjac flour gradually to the warm water, and continue mixing for 5-10 minutes until all konjac flour is dissolved. Subsequently, gradually add other starchy ingredients to the water in which konjac flour is dissolved in a ratio of 1:1-2 by weight with constant mixing. Equilibration is conducted with gentle but sufficient agitation to prevent agglomeration or the formation of clumps. Equilibration can last for approximately 15 to 30 minutes. All the liquid ingredients can then be added and mixed. Finally, prepare another cocktail of the remainder non-starchy solid ingredients and mix with the cocktail prepared from the above.

Heat-tolerant vitamins can be added to the cocktail, whereas heat sensitive vitamins are typically added by topical application to the RTE cereal.

Cooking and Forming into Desirable Shape and Sized Pieces

The cereal dough can be cooked using a batch, atmospheric cooker or a low pressure extruder cooker. It is cooked with steam for a period of time and at temperatures sufficient to gelatinize the cereal starch and to develop desired levels of cooked cereal flavor. The temperature of the cooked cereal dough is in the range of 120-180° C. The operating pressure is in the range of 2800-3200 kPa. The cooked cereal dough typically has a moisture content of 25-35% by weight.

Conventional techniques and equipments can be employed to form the cooked cereal dough into individual pieces of desirable size and shape. The cooked cereal dough can be sheeted to form sheets of dough and cut into individual pieces. The cooked dough can also be extruded through a die to form a desirable rope-shape. The dough rope can be subsequently cut to form individual shaped pieces. Alternatively, the cooked cereal dough can be fed to a biscuit forming device which forms the dough into biscuit shaped individual pieces.

The cereal product can be fabricated into flakes or other snack forms including shreds, biscuits, mini-biscuits, and rings. The present cereal composition can also be formulated and fabricated to provide puffed cereals of various shapes and sizes.

### Drying to Form Finished Pieces

Because of strong water-retention property of konjac flour, lower temperatures and prolonged drying periods were employed in the drying process. The first step of drying is to achieve moisture content of approximately 10-15%, which can be accomplished using equipments such as rotary bed, tray, or belt dryers. Simple hot air convection drying, e.g., 80-120° C., is the preferred technique. Typical drying time is 10-20 minutes. Equilibration is needed to allow moisture to equilibrate within the pellets. It takes approximately 60-90 minutes to form tempered dried pellets. Subsequently, the pellets are heated at a temperature of approximately 75-80° C., followed by flaking to form wet flakes. The finale drying step is toasting, which causes a tendering and slight expansion of the R-T-E cereal flakes. Flake cereal is tenderized, toasted and partially expanded by rapid heating of the wet flakes which converts the dense, hard, wet flakes into more palatable, porous, tender flakes, and also to enhance the color and flavor of the finished cereal product. Toasting can be accomplished by heating the wet flakes, usually at 95-285° C. Toasting of the R-T-E cereal pieces can be conducted in conventional dryers, vacuum dryers or other commercial baking equipment. Preferably, the wet flakes are toasted until moisture content of approximately 2-6% is obtained. Such toasting typically requires heating for about 6-12 minutes.

Alternatively, the dough can be extruded under conditions of temperature and pressure to form individual expansions puffed RTE cereal or snack pieces. The other option, although less preferred, the pieces or pellets can be fried to form dried puffed fried finished cereal products.

A range of temperature and drying time is provided above, however, the exact temperature and time of drying should be adjusted based on the amount of konjac flour as well as the size and shape of the finale products.

### Topical Coating

If desired, topical coating with sweetener, vitamin or minerals can be done following any conventional method.

### Final Cereal Product

A topical sugar coating can be added to form pre-sweetened RTE finished cereal pieces. Alternatively, an oil topical coating with salt and/or flavors can be applied to form finished dried snack products.

The finished dried cereal can be mixed with other dry snack ingredients (e.g., nuts, dried fruit pieces, pretzel, and other cereal pieces) to form a mixed aggregate snack product.

The RTE cereal pieces can then be packaged for distribution and sale.

The finished RTE cereal product is remarkably similar to its conventional counterparts, although it contains significant amount of konjac flour. The product is characterized by good flavor, good texture and more importantly associated with significant health benefits including weight control and management.

Since the invention may be embodied in other specific forms without departing from the spirit or general characteristics thereof, the embodiments described herein are to be considered in all respects illustrative and not restrictive. The scope of the invention is to be indicated by the appended claims, rather than by the forgoing description, and all changes, which come within the meaning and range of equivalency of the claims, are intended to be embraced therein.

What is claimed is:

1. A R-T-E cereal with konjac as a main ingredient, comprising of konjac flour in quantities of 3-10% by dry weight; other starchy ingredients in quantities of 70-85% by dry weight; other optional ingredients in quantities of 0.5-10% by dry weight; and water in quantities of approximately 5-10 folds by weight of konjac flour.

2. The process of claim 1, wherein the mixture has a konjac flour content of approximately 3-10% of said composition.

3. The process of claim 1, wherein the mixture contains minimally one of the starchy ingredients including cereal grains, cut grains, grits or flours from rice, corn, wheat, oats, barley, rye, or other cereal grains in quantities of 70-85% by dry weight of said composition.

4. The process of claim 1, wherein the mixture contains other optional ingredients including vitamin/mineral fortification, colors, flavors, salt, nutritive carbohydrate sweetening agents, corn and malt syrup in quantities of 0.5-10% by dry weight of said composition.

5. The process of claim 1, wherein the mixture has a water content of approximately 5-10 folds of konjac flour by weight.

6. A method of manufacturing R-T-E cereal containing konjac flour as a main ingredient comprising of (a) dissolve konjac flour with 5-10 fold of warm water by weight at temperature of 45-55° C.; (b) add other starchy ingredients to the konjac/water solution in a ratio of 1:1-2 by weight; (c) equilibrate with gentle agitation for 15-30 minutes; (d) mix with other liquid ingredients; (e) prepare a cocktail of the remainder non-starchy solid ingredients and blend with the mixture formed in (d); (f) cook the cereal dough and form desirable shape and sized pieces; (g) dry at temperature of 85-125° C.; (h) equilibrate for approximately 60-90 minutes; (i) pre-heating and flaking; (j) toasting at temperature of 100-250° C. for 6-12 minutes; and (k) topical coating if desired.

7. The process of claim 6, wherein konjac flour is mixed with 5-10 fold of warm water by weight at temperature of 45-55° C. for 5-10 minutes until it is fully dissolved.

8. The process of claim 6, wherein other starchy ingredients is mixed with pre-dissolved konjac flour in water in a ratio of 1:1-2 by weight.

9. The process of claim 6, wherein equilibration is conducted with gentle but sufficient agitation for approximately 15-30 minutes.

10. The process of claim 6, wherein all other liquid ingredients can be added and mixed.

11. The process of claim 6, wherein a cocktail of the remainder non-starchy solid ingredients is prepared separately and blended with the cocktail formed in the step 10.

12. The process of claim 6, wherein the cereal dough is cooked at a temperature of 120-180° C. and with pressure preferably in the range of 2800-3200 kPa.

13. The process of claim 6, wherein the cooked cereal dough can form individual pieces of desirable size and shape by one of the following procedures: (a) sheeted to form sheets and cut into individual pieces; (b) extruded through a die to form rope-shape and can be subsequently cut to form individual pieces; or (c) fed to a biscuit forming device to form biscuit-shaped individual pieces.

14. The process of claim 6, wherein the drying process is conducted according to the following procedures (a) drying at temperature of 80-120° C. for 10-20 minutes; (b) equilibration for approximately 60-90 minutes; (c) pre-heating at a temperature of 75-80° C. followed by flaking to form wet flakes; and (d) toasting wet flakes at temperature of 95-285° C. for approximately 6-12 minutes.

15. The process of claim 6, wherein topical coating with sweetener, vitamin or minerals is optional.
